(19) United States
(12) Patent Application Publication
(10) Pub. No.: US 2021/0341770 A1
(43) Pub. Date: Nov. 4, 2021

(54) DISPLAYS WITH MULTIPLE PRIVACY MODES

(71) Applicant: Hewlett-Packard Development Company, L.P., Spring, TX (US)

(72) Inventors: Hsing-Hung Hsieh, Taipei City (TW); Wan Ching Lee, Taipei City (TW); Yu Cheng Tsai, Taipei City (TW)

(73) Assignee: Hewlett-Packard Development Company, L.P., Spring, TX (US)

(21) Appl. No.: 17/271,232

(22) PCT Filed: Nov. 16, 2018
(86) PCT No.: PCT/US2018/061611

§ 371 Date: Feb. 25, 2021

(51) Int. Cl. G02F 1/13; G02F 1/1335; G06F 21/84

(52) U.S. Cl. CPC G02F 1/1323; G02F 1/133528; G02F 1/133514; G02F 1/133526; G06F 21/84

(57) ABSTRACT

An example display device with a multiple privacy mode of operation includes a micro lens cell having a first liquid crystal layer with a first set of liquid crystal molecules and a controllable optical effective refractive index, to transmit light through the micro lens cell. A pair of electrodes receive a voltage to change an orientation of the first set of liquid crystal molecules and the optical effective refractive index of the first liquid crystal layer. A micro lens array directs the light at an interface of the micro lens array and first liquid crystal layer. The micro lens array directs the light at different angles based on the voltage. A second liquid crystal layer changes a polarization of the light. A color filter controls a color of the light. A common electrode controls an orientation of a second set of liquid crystal molecules in the second liquid crystal layer.

### BACKGROUND

Display devices utilize light to display images. Content may be displayed on the display devices. The content may be kept private by utilizing shielding screens and other mechanical add-on mechanisms to the display device.

### BRIEF DESCRIPTION OF THE DRAWINGS

The following detailed description references the drawings, in which:

FIG. 1A is a cross-sectional diagram illustrating a display device with a multiple privacy mode of operation, according to an example.

FIG. 1B is cross-sectional diagram illustrating the display device of FIG. 1A with a multiple privacy mode of operation, according to another example.

FIG. 1C is cross-sectional diagram illustrating the transmission of light at a wide viewing angle through a micro lens cell of the display device of FIG. 1A, according to an example.

FIG. 1D is cross-sectional diagram illustrating the transmission of light at a narrow viewing angle through a micro lens cell of the display device of FIG. 1A, according to an example.

FIG. 2 is a cross-sectional diagram illustrating the transmission of light based on a viewing angle of a user of the display device of FIG. 1A, according to an example.

FIG. 3 is a cross-sectional diagram illustrating the transmission of light at various angles from the display device of FIG. 1A, according to an example.

FIG. 4 is a cross-sectional diagram illustrating the transmission of light at various angles resulting in a visually white light being displayed by the display device of FIG. 1A, according to an example.

FIG. 5 is a cross-sectional diagram illustrating the transmission of light at various angles when the common electrode is off of the display device of FIG. 1A, according to an example.

FIG. 6 is a cross-sectional diagram illustrating the transmission of light at an angle causing black light to be displayed by the display device of FIG. 1A, according to an example.

FIG. 7 is a block diagram illustrating an electronic device to transmit light for controlling various modes of operation of a display, according to an example.

FIG. 8 is a block diagram illustrating the processor of the electronic device of FIG. 7 selecting a first privacy mode of operation, according to an example.

FIG. 9 is a block diagram illustrating the processor of the electronic device of FIG. 7 selecting a second privacy mode of operation, according to an example.

FIG. 10 is a block diagram illustrating the processor of the electronic device of FIG. 7 selecting a third privacy mode of operation, according to an example.

FIG. 11A is a flow diagram illustrating a method of transmitting light to control multiple privacy modes of operation in a display device, according to an example.

FIG. 11B is a flow diagram illustrating a method of refracting light, according to an example.

FIG. 11C is a flow diagram illustrating a method of collimating light, according to an example.

FIG. 11D is a flow diagram illustrating a method of changing an orientation of liquid crystal molecules to control the direction of light, according to an example.

FIG. 11E is a flow diagram illustrating a method of altering the display of light from a display device based on a viewing angle of a user, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A user may use a laptop, notebook, or other computing device in a public setting, such as on an airplane. The user may seek to keep the contents of the display private when in a public setting. In such a scenario, for example, the user may have other people seated adjacent to the user and within a viewing distance and angle of the contents displayed on the display screen of the user's device. Sometimes the user may install mechanical privacy screens to help shield the contents from onlookers. However, this is not very discrete and requires additional equipment, which a traveler may wish to avoid. In other situations, the user may also wish to share the contents of the display screen when desired with other people adjacent to the user. Removal of the privacy screen would be required, which can be awkward especially if the user wishes to switch back to a privacy setting later.

An example herein provides for multiple privacy modes of display devices such as laptops, notebooks, and tablet computers. When a user of the device desires to ensure that the contents being displayed are relatively private from individuals who are adjacent to the user, then the display device may be switched between various modes of operation that may present either a white screen or a black screen to the adjacent individuals to ensure privacy of the contents being displayed. Alternatively, the actual contents of the display screen may be displayed to the adjacent individuals in a sharing mode. The different modes of display may be controlled in the display device by changing the angle of the light being transmitted through the device. This occurs by incorporating a micro lens cell structure containing a micro lens array and a layer of liquid crystals. When voltage is applied to a pair of electrodes adjacent to the layer of liquid crystals, then the liquid crystal molecules change their orientation, which changes the effective refractive index of the liquid crystals and creates different delta of refractive index of the liquid crystals and the micro lens cell structure. The change in the effective refractive index facilitates the change in the modes of operation; e.g., the modes of display of the device.

The electronic device may function in three modes of operation; namely, a sharing mode, a white-light privacy mode, and a black-light privacy mode. The sharing mode allows the user of the electronic device to share the contents of the screen with people adjacent to the user and the display screen of the electronic device. The white-light privacy mode outputs a scattered light or white screen image on the display screen such that the user who is centrally positioned with respect to the device may still view the contents on the display screen in a normal manner. However, people who are adjacent to the display screen would only see a white image at their viewing angle. Similarly, the black-light privacy mode outputs a low intensity of light or black screen image on the display screen such that the user who is centrally positioned with respect to the device may still view the contents on the display screen in a normal manner. However, people who are adjacent to the display screen would only see a black image at their viewing angle. The user of the device may toggle between the various modes of operation by pressing a switch on the device, display screen, or keyboard, or by selecting a graphical user interface on the display screen, for example. Selecting the black light or image may be utilized in situations where the user does not wish to output a bright white light to people adjacent to the user and device; e.g., creating the so-called blinking effect to others. For example, in an airplane scenario the cabin lights may be dimmed to allow passengers to sleep, and a white light may be disturbing for such a purpose. Accordingly, the black light would allow for a private use of the device while also not outputting a bright light to others next to the user.

An example of a display device with a multiple privacy mode of operation comprises a micro lens cell comprising a first liquid crystal layer with a first set of liquid crystal molecules and a controllable optical effective refractive index, to transmit light through the micro lens cell; a pair of electrodes to receive a voltage to change an orientation of the first set of liquid crystal molecules and the optical effective refractive index of the first liquid crystal layer; and a micro lens array to direct the transmitted light at an interface of the micro lens array and the first liquid crystal layer. The micro lens array is to direct the transmitted light at different angles based on the voltage received by the pair of electrodes. The device comprises a second liquid crystal layer to change a polarization of the light; a color filter proximate to the second liquid crystal layer to control a color of the light to be output; and a common electrode adjacent to the color filter to control an orientation of a second set of liquid crystal molecules in the second liquid crystal layer.

The light being output from the display device may comprise (i) a first angle comprising a first field of vision that extends from a center view of the display device to approximately 30-45° in each direction, and (ii) a second angle comprising a second field of vision that extends from approximately 30-45° up to 90° in each direction. When the micro lens cell is to direct the transmitted light at the first angle and the second angle, and the common electrode is turned on, the light being output from the display device may be scattering and visually white in the second field of vision, and the light being output from the display device is not scattering in the first field of vision. When the micro lens cell is to direct the transmitted light at the first angle and the second angle, and the common electrode is turned off, the light being output from the display device is the same in the first field of vision and the second field of vision. When the micro lens cell is to direct the transmitted light at the first angle, the light being output from the display device may be lowered in intensity and visually black in the second field of vision.

Another example provides an electronic device comprising a liquid crystal display that alters between a multiple privacy mode of operation and comprising a backlight unit to transmit light; a thin film transistor component with a pixel electrode; a first liquid crystal layer interfacing with a micro lens array, in between the backlight unit and the thin film transistor component, to alter a projection of the transmitted light from a first projection angle to a second projection angle; and a color filter with a common electrode to filter the transmitted light for output. The electronic device comprises a processor to control privacy modes of operation of the liquid crystal display, wherein the processor is to control a first effective refractive index of the first liquid crystal layer by electrically switching an orientation of the first liquid crystal layer; set the first effective refractive index of the first liquid crystal layer and an effective refractive index of the micro lens array to be congruent for transmission of the light at the first projection angle; and set a second effective refractive index of the first liquid crystal layer and the effective refractive index of the micro lens array to be incongruent for transmission of the light at the second projection angle.

The electronic device comprises a switch to transmit a signal to the liquid crystal display and the processor to toggle between the modes of operation. The processor may select a first privacy mode of operation by transmitting instructions to the liquid crystal display to output a low light intensity screen which is visually black, at a viewing angle greater than approximately +30-45° from a center viewing angle of the liquid crystal display. The processor may select a second privacy mode of operation by transmitting instructions to the liquid crystal display to output a light scattering screen which is visually white, at a viewing angle greater than approximately ±30-45° from a center viewing angle of the liquid crystal display. The processor may select a third privacy mode of operation, which is sharing mode, by transmitting instructions to the liquid crystal display to output a normal screen display at a viewing angle greater than approximately ±30-45° from a center viewing angle of the liquid crystal display, and wherein the normal screen display comprises a screen display output that occurs when viewed at an approximately 0° angle from the center viewing angle of the liquid crystal display.

Another example provides a method of transmitting light to control a multiple privacy mode of operation in a display device, the method comprising providing light at a first projection angle in the display device; directing the light at the first projection angle through a micro lens cell comprising a liquid crystal layer and a micro lens array; controlling an optical effective refractive index of the liquid crystal layer to cause the light to change directions between the first projection angle and a second projection angle by aligning the optical effective refractive index of the liquid crystal layer and the micro lens array at the first projection angle, and misaligning the optical effective refractive index of the liquid crystal layer and the micro lens array at the second projection angle; filtering the light; and outputting the light from the display device.

The method may comprise refracting the light through the micro lens cell when the direction of the light changes to the second projection angle. The method may comprise collimating the light when the direction of the light changes to the second projection angle. The method may comprise applying a voltage to a pair of electrodes in the micro lens cell to change an orientation of liquid crystal molecules in the liquid crystal layer to cause the light to change directions between the first projection angle and the second projection angle. The method may comprise altering the display of the light from the display device based on a viewing angle of a user of the display device. The various descriptions of materials, dimensions, configurations, and other parameters provided in the examples below are provided for exemplary purposes only, and the examples are not restricted to these particular materials, dimensions, configurations, and parameters, etc.

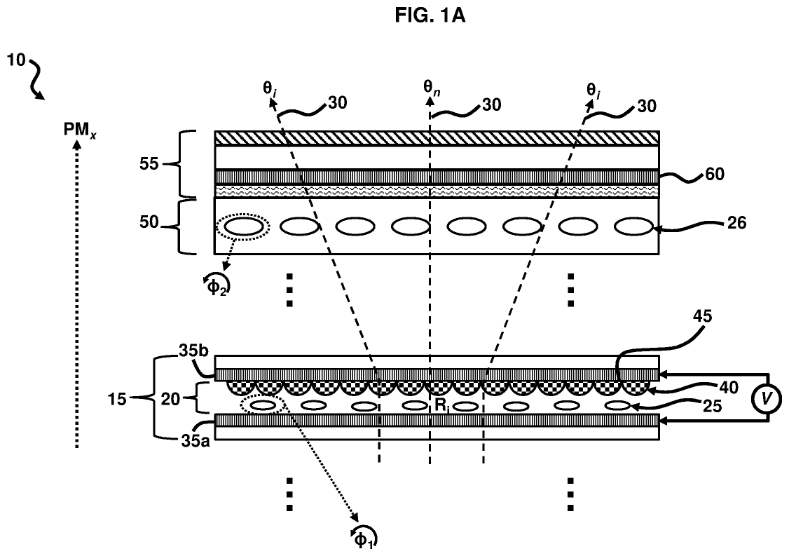

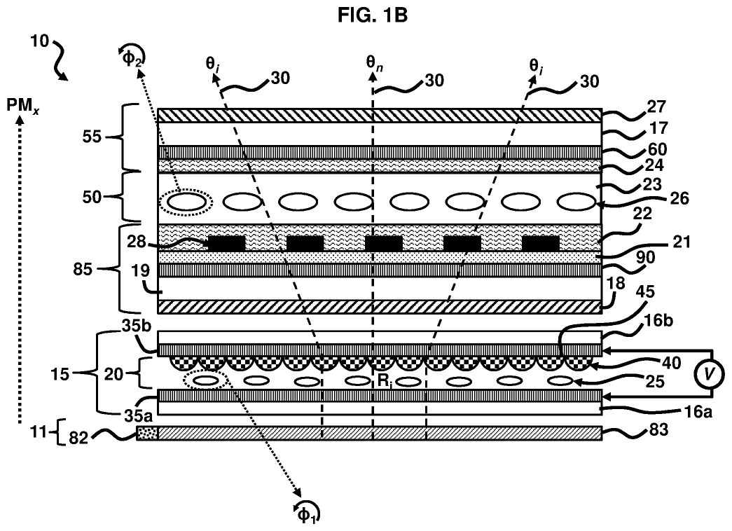

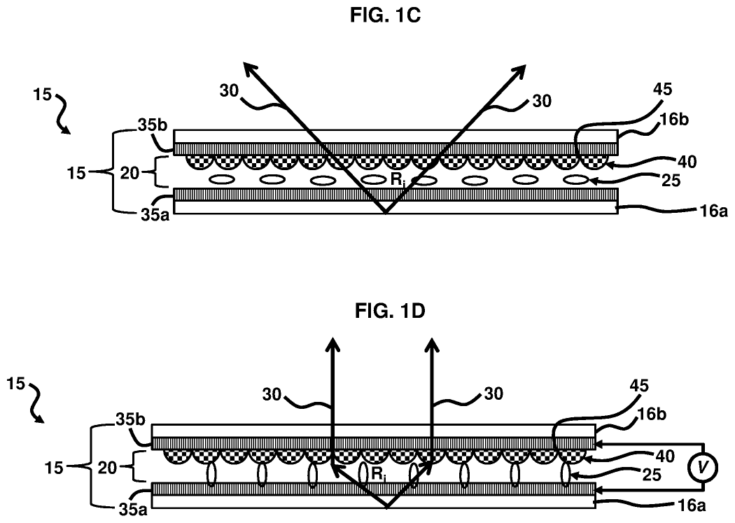

FIG. 1 illustrates a display device 10 with a multiple privacy mode of operation PMₓ, The display device 10 may be part of an overall computing or electronic system, or it may be a self-contained display device 10 comprising its own processing and memory capabilities, etc. In an example, the display device 10 may comprise a liquid crystal display (LCD) device, which may be connected to a laptop, notebook computer, or any other computing device (not shown). Images may be displayed and/or projected on/from the display device 10 and may be engaged through touch sensing. The image may include any of still images and video images and combinations thereof, and may include a full spectrum of colors generated by a red (R), green (G), and blue (B) combination of pixels, according to an example.

According to an example, the display device 10 comprises a micro lens cell 15 comprising a first liquid crystal layer 20 with a first set of liquid crystal molecules 25 and a controllable optical effective refractive index Rᵢ, to transmit light 30 through the micro lens cell 15. In an example, the first liquid crystal layer 20 may be approximately 15 to 20 μm in thickness and the first set of liquid crystal molecules 25 may be approximately 10 to 15 μm in thickness, although other thicknesses are possible. In an example, the first liquid crystal layer 20 may comprise a polymer material, which may be a translucent material, and is positioned to receive the light 30 and redirect the light 30 in various angles/directions. The first set of liquid crystal molecules 25 may be dissolved or dispersed into a liquid polymer followed by a solidification or curing to create the first liquid crystal layer 20. During the change of the polymer from a liquid to a solid first liquid crystal layer 20, the first set of liquid crystal molecules 25 become materially incompatible with the solid first liquid crystal layer 20 and form droplets throughout the solid first liquid crystal layer 20. These droplets are referred to as the first set of liquid crystal molecules 25 as shown in the figures and described herein.

According to an example, a pair of electrodes 35a, 35b are provided to receive a voltage V to change an orientation ϕ₁ of the first set of liquid crystal molecules 25 and the optical effective refractive index Rᵢ of the first liquid crystal layer 20. In an example, the pair of electrodes 35a, 35b may comprise transparent conductive materials such as indium tin oxide (ITO) or silver nanowire films (AgNWs). According to an example, the voltage V may be applied by any suitable voltage source and at any voltage level suitable for the pair of electrodes 35a, 35b. According to an example, the voltage V comprises an AC voltage. Application of the voltage V creates the electric field, which electrically actuates the first liquid crystal layer 20 causing a change in the orientation ϕ₁ of the first set of liquid crystal molecules 25. The voltage V may be turned on or off to cause the orientation ϕ₁ of the first set of liquid crystal molecules 25 to change from a uniform orientation to a random or non-uniform orientation, respectively, which automatically changes the optical effective refractive index Rᵢ of the first liquid crystal layer 20. In other words, when the voltage Vis turned on causing the electric field to electrically actuate the first liquid crystal layer 20, the orientation ϕ₁ of the first set of liquid crystal molecules 25 may be uniform. Conversely, when the voltage Vis turned off causing no electric field and resulting in no electrical actuation of the first liquid crystal layer 20, the orientation ϕ₁ of the first set of liquid crystal molecules 25 may be non-uniform or random, which causes the change in the optical effective refractive index Rᵢ of the first liquid crystal layer 20. In another example, instead of an on/off attribute for controlling the voltage V, there may be an attenuation of the voltage V to below a threshold voltage level that is sufficient to create an adequate electric field in order to cause the orientation ϕ₁ of the first set of liquid crystal molecules 25 to change from a uniform orientation to a random or non-uniform orientation. In this regard, the voltage V may not be turned off completely to cause the orientation ϕ₁ of the first set of liquid crystal molecules 25 to become random or non-uniform, but rather once the level of the voltage V decreases below the threshold level, then the electric field is no longer sufficiently strong to cause the orientation ϕ₁ of the first set of liquid crystal molecules 25 to become random or non-uniform.

According to an example, a micro lens array 40 is provided to direct the transmitted light 30 at an interface 45 of the micro lens array 40 and the first liquid crystal layer 20. The micro lens array 40 is provided to direct the transmitted light 30 at different angles θᵢ, θₙ based on the voltage V received by the pair of electrodes 35a, 35b, in an example. The micro lens array 40 may comprise a set of micro lenses, which may each of diameters as small as 10 μm according to some examples, and which provide optical transmission of the light 30 directed therethrough. The micro lens array 40, which may be substantially semicircular in shape, may use refractive techniques in order to direct the light 30 at the different angles θᵢ, θₙ. In an example, the micro lens array 40 may be less than approximately 10 μm in thickness, although other thicknesses are possible. When the voltage Vis applied to the pair of electrodes 35a, 35b and the orientation ϕ₁ of the first set of liquid crystal molecules 25 changes from a uniform orientation to a non-uniform orientation, then the direction of the light 30 that is transmitted through the first liquid crystal layer 20 may also be altered upon interacting with the first set of liquid crystal molecules 25, which causes the light 30 to be directed at the different angles θ₁, θₙ.

In an example, a second liquid crystal layer 50 is provided to change a polarization of the light 30. The second liquid crystal layer 50 may comprise a second set of liquid crystal molecules 26. In an example, the second liquid crystal layer 50 may comprise a polymer material, which may be a translucent material, and is positioned to receive the light 30 and redirect the light 30 in various angles/directions thereby changing the polarization of the light 30. The second set of liquid crystal molecules 26 may be dissolved or dispersed into a liquid polymer followed by a solidification or curing to create the second liquid crystal layer 50. During the change of the polymer from a liquid to a solid second liquid crystal layer 50, the second set of liquid crystal molecules 26 become materially incompatible with the solid second liquid crystal layer 50 and form droplets throughout the solid second liquid crystal layer 50. These droplets are referred to as the second set of liquid crystal molecules 26 as shown in the figures and described herein.

In an example, a color filter 55 is positioned proximate to the second liquid crystal layer 50 to control a color of the light 30 to be output. The color filter 55 may comprise different colored pixels to adjust the color the light 30 to be output. A common electrode 60 is provided adjacent to the color filter 55 to control an orientation ϕ₂ of the second set of liquid crystal molecules 26 in the second liquid crystal layer 50. In an example, the common electrodes 60 may comprise transparent conductive materials such as ITO or AgNW films. While not shown in FIG. 1A, the common electrode 60 may control the orientation ϕ₂ of the second set of liquid crystal molecules 26 in the second liquid crystal layer 50 through the application of a voltage by any suitable voltage source and at any voltage level suitable for the common electrodes 60. According to an example, the voltage comprises an AC voltage. Application of the voltage to the common electrode 60 creates the electric field, which electrically actuates the second liquid crystal layer 50 causing a change in the orientation ϕ₂ of the portion of the second set of liquid crystal molecules 26 that is near the common electrode 60. The voltage to the common electrode 60 may be turned on or off to cause the orientation ϕ₂ of the second set of liquid crystal molecules 26 to change to second orientation from an original or first orientation. In other words, when the voltage to the common electrode 60 is turned on causing the electric field to electrically actuate the second liquid crystal layer 50, the orientation ϕ₂ of the second set of liquid crystal molecules 26 may be in a certain orientation that scatters the light, particularly for a large viewing angle. Conversely, when the voltage to the common electrode 60 is turned off causing no electric field and resulting in no electrical actuation of the second liquid crystal layer 50, the orientation ϕ₂ of the first set of liquid crystal molecules 26 may be in an original orientation. In another example, instead of an on/off attribute for controlling the voltage to the common electrode 60, there may be an attenuation of the voltage to the common electrode 60 to below a threshold voltage level that is sufficient to create an adequate electric field in order to cause the orientation ϕ₂ of the second set of liquid crystal molecules 26 to change from a first orientation to a second orientation.

According to some examples, the multiple privacy mode of operation PMₓ, may include displaying the light 30 as scattering light (e.g., visually white), low light intensity (e.g., visually black), or normal color/display from the display device 10. The change in orientation ϕ₁ of the first set of liquid crystal molecules 25 may control the changes in the privacy mode of operation PMₓ. In the exemplary drawing in FIG. 1A, the display device 10 may contain additional layers, films, and components, etc. in between the micro lens cell 15 and the second liquid crystal layer 50, as well as on the other side of the micro lens cell 15. These additional layers, films, and components, etc. are described in further detail below.

FIG. 1B, with reference to FIG. 1A, illustrates the aforementioned additional layers, films, and components in the display device 10, according to an example. The display device 10 may comprise a backlight unit 11 comprising a light emitting unit 82 to generate the light 30 and a light guide plate 83 to disperse the light 30 in selected directions towards the micro lens cell 15. The light emitting unit 82 may comprise a light emitting diode (LED), a fluorescent lamp, or other type of component capable of emitting light 30. The light 30 may be emitted in a substantially uniform manner or may be directed non-uniformly according to various examples. Moreover, according to an example, the light emitting unit 82 may selectively emit the light 30 such that only portions of the light emitting unit 82 emit light 30, or the light 30 may be emitted in phases and intensities from the light emitting unit 82 including in a strobe-like effect. The light 30 may be directed linearly away from the light emitting unit 82 and angularly, according to some examples. Furthermore, the intensity of the light 30 may be based on the power of the light emitting unit 82. The light guide plate 83 is positioned adjacent to the light emitting unit 82. The light guide plate 83 may contact the light emitting unit 82 or may be slightly spaced apart from the light emitting unit 82. The light guide plate 83 may comprise translucent material to permit light 30 to enter and exit therethrough. In an example, the light guide plate 83 may transmit the light 30 emitted from the light emitting unit 82. Accordingly, the light guide plate 83 may transmit the light 30 through any of the top, bottom, and sides of the light guide plate 83. Although not shown, a reflector may be positioned adjacent to the light guide plate 83 to reflect the light 30 towards the micro lens cell 15.

According to an example, the micro lens cell 15 comprises a pair of substrates 16a, 16b each adjacent to the respective pair of electrodes 35a, 35b. In an example, the pair of electrodes 35a, 35b may each be approximately 400 to 1200 nm in thickness, although other suitable thicknesses are possible. The substrates 16a, 16b may comprise glass, poly(methyl methacrylate) (PMMA), polyimide, or plastic material according to some examples. In an example, the substrates 16a, 16b may each be approximately 0.1 to 0.4 mm in thickness, although other suitable thicknesses are possible. A thin film transistor component 85 is positioned adjacent to the micro lens cell 15. According to an example, the thin film transistor component 85 comprises a polarizer 18 to filter the light 30, a substrate 19, a common electrode 90, an insulator 21, and an alignment layer 22 containing at least one pixel electrode 28. In an example, the common electrodes 90 and the at least one pixel electrode 28 may each be approximately 400 to 1200 nm in thickness, although other suitable thicknesses are possible. The substrate 19 may comprise glass, PMMA, polyimide, or plastic material according to some examples. In an example, the substrate 19 may be approximately 0.1 to 0.4 mm in thickness, although other suitable thicknesses are possible. In an example, the insulator 21 may comprise silicon oxide or a polymer material, and may be approximately 3000 to 15000 nm in thickness, although other suitable thicknesses are possible. The second liquid crystal layer 50 may comprise a second liquid crystal layer 23 containing the second set of liquid crystal molecules 26. In an example, the second liquid crystal layer 23 may be approximately 5 to 15 μm in thickness and each of the molecules in the second set of liquid crystal molecules 26 may be approximately 10 μm in thickness, although other thicknesses are possible. The color filter 55 may comprise an alignment layer 24 supporting the common electrode 60. In an example, the common electrode 60 may be approximately 400 to 1200 nm in thickness, although other suitable thicknesses are possible. In an example, the alignment layers 22, 24 may comprise polymide material and may be approximately a few tenths of an angstrom in thickness, although other suitable thicknesses are possible. A substrate 17 and a polarizer 27 may be positioned on the common electrode 60. The substrate 17 may comprise glass, PMMA, polyimide, or plastic material according to some examples. In an example, the substrate 17 may be approximately 0.1 to 0.4 mm in thickness and the polarizer 27 may be approximately 0.1 mm in thickness, although other suitable thicknesses are possible.

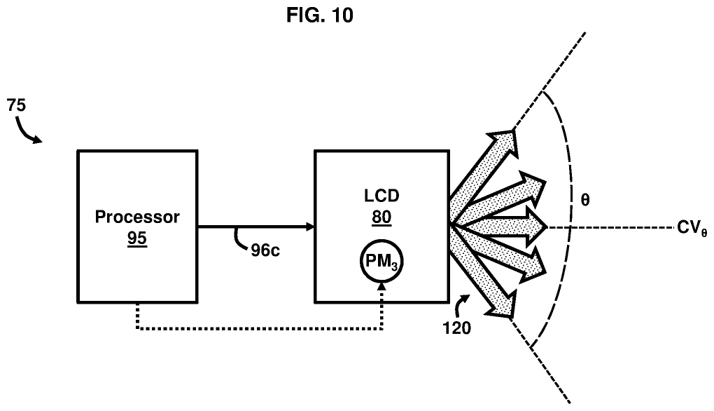

FIG. 10, with reference to FIGS. 1A and 1B, illustrates a wide viewing angle example. In this privacy mode of operation PMₓ, the first set of liquid crystal molecules 25 has an optical effective refractive index Rᵢ that is the same as the micro lens array 40, thus the light 30 can just pass through in a wide viewing angle. When the micro lens cell 15 is switched at a wide viewing angle, and the common electrode 60 in the color filter 55 is on, the display device 10 is in a white light privacy mode of operation PMₓ. When the micro lens cell 15 is switched at a wide viewing angle, and the common electrode 60 in the color filter 55 is off, the display device 10 is in a sharing mode of operation, which is considered a type of privacy mode of operation PMₓ according to an example. FIG. 1D, with reference to FIGS. 1A through 10, illustrates a narrow viewing angle. In this privacy mode of operation PMₓ, the first set of liquid crystal molecules 25 has an optical effective refractive index Rᵢ that is not the same as the micro lens array 40 when the voltage Vis applied to the pair of electrodes 35a, 35b, thus the light 30 is refracted by the micro lens array 40 resulting in a narrow viewing angle. In an example, when micro lens cell 15 is switched at the narrow viewing angle, the display device 10 may be in a black light privacy mode of operation PMₓ if the light 30 does not transmit all the way through the micro lens cell 15. In another example, when micro lens cell 15 is switched at the narrow viewing angle, the display device 10 may be in a white light privacy mode of operation PMₓ if the light 30 transmits all the way through the micro lens cell 15.

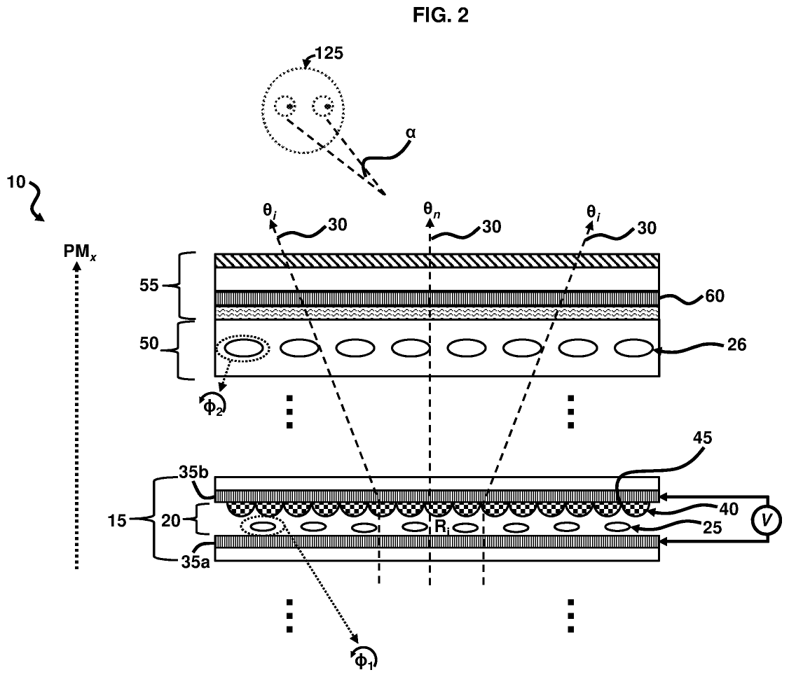

As shown in FIG. 2, with reference to FIGS. 1A through 1D, the light 30 may be displayed from the display device 10 based on a viewing angle α of a user 125 of the display device 10. More particularly, the light 30 may be displayed from the display device 10 based on a viewing angle α of a user 125 of the display device 10 in combination with the privacy mode of operation PMₓ that the display device 10 is set to be operable. In this regard, when the viewing angle α of the user 125 is positioned such that the user 125 is positioned next to the display device 10, then the light 30 may be displayed as any of a white light, black light, and normal display light. For example, if the display device 10 is positioned on a table (not shown) and the user 125 is seated next to the table; i.e., the user 125 is seated next to the display device 10, then the privacy mode of operation PMₓ may be determined based on the viewing angle α of the user 125.

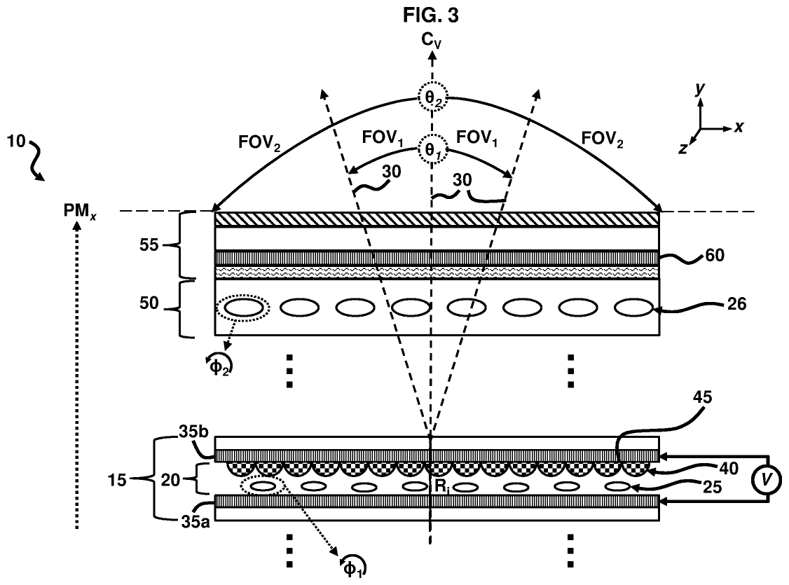

As shown in FIG. 3, with reference to FIGS. 1A and 2, the light 30 being output from the display device 10 comprises (i) a first angle θ₁ comprising a first field of vision FOV₁ that extends from a center view Cv of the display device 10 to approximately 30-45° in the x and z directions, and (ii) a second angle θ₂ comprising a second field of vision FOV₂ that extends from approximately 30-45° up to 90° in the x and z directions. The light 30 displayed in either the first field of vision FOV₁ or the second field of vision FOV₂ may be displayed according to the particular privacy mode of operation PMₓ in which the display device 10 is selected to be operable.

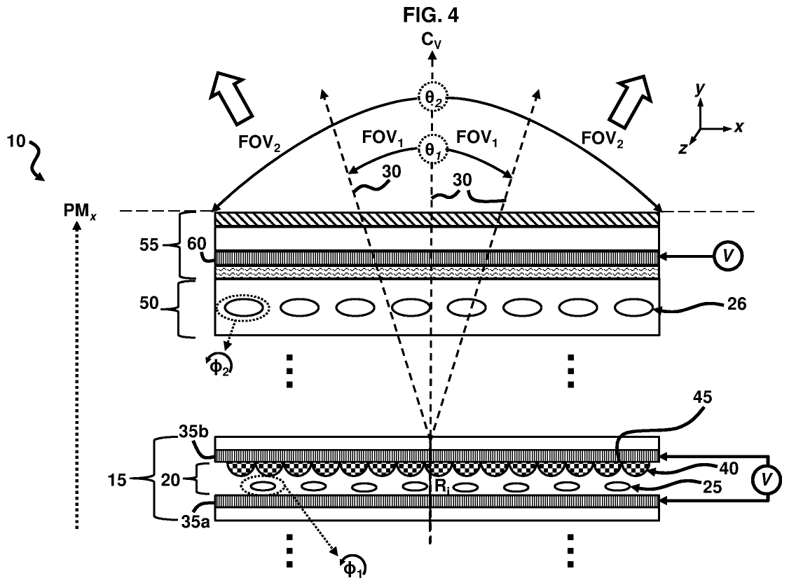

As shown in FIG. 4, with reference to FIGS. 1A through 3, when the micro lens cell 15 is to direct the transmitted light 30 at the first angle θ₁ and the second angle θ₂, and the common electrode 60 is turned on by applying a voltage V, the light 30 being output from the display device 10 is scattering and visually white in the second field of vision FOV₂, and the light 30 being output from the display device 10 is not scattering in the first field of vision FOV₁. In this regard, the light 30 being output from the display device 10 that is not scattering in the first field of vision FOV₁ may be in a normal display mode; i.e., normal color of light 30 that is being displayed or output by the display device 10. However, the light 30 that is being output from the display device 10 in the second field of vision FOV₂ is in a privacy mode of operation PMₓ by outputting light 30 that is white and as such, the content being displayed in the normal display color of light 30 in the first field of vision FOV₁ is not viewable in the second field of vision FOV₂.

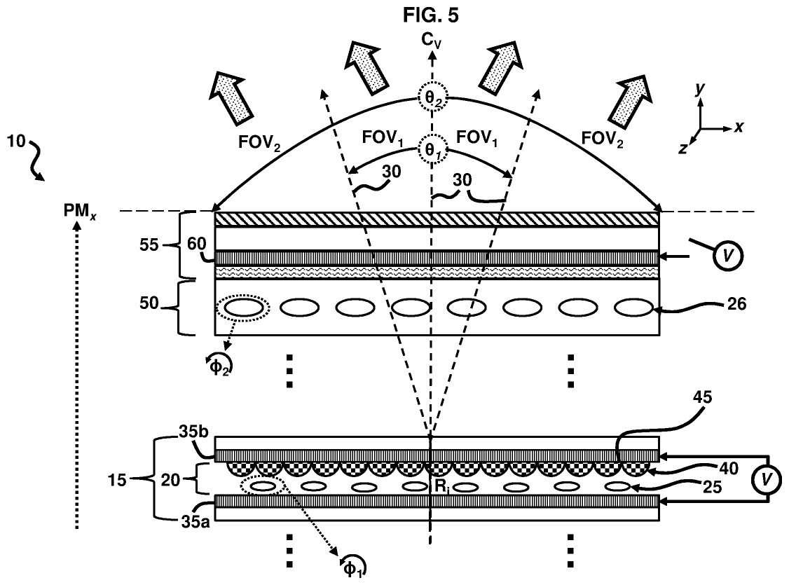

As shown in FIG. 5, with reference to FIGS. 1A through 4, when the micro lens cell 15 is to direct the transmitted light 30 at the first angle θ₁ and the second angle θ₂, and the common electrode 60 is turned off, the light 30 being output from the display device 10 is the same in the first field of vision FOV₁ and the second field of vision FOV₂. In this regard, the light 30 being output from the display device 10 may be in a normal display mode; i.e., normal color of light 30 that is being displayed or output by the display device 10. This may also be referred to as a sharing mode of operation; i.e., the content being displayed on the display device 10 in the first field of vision FOV₁ may be shared with another user 125 that is adjacent to the display device 10 and in the second field of vision FOV₂.

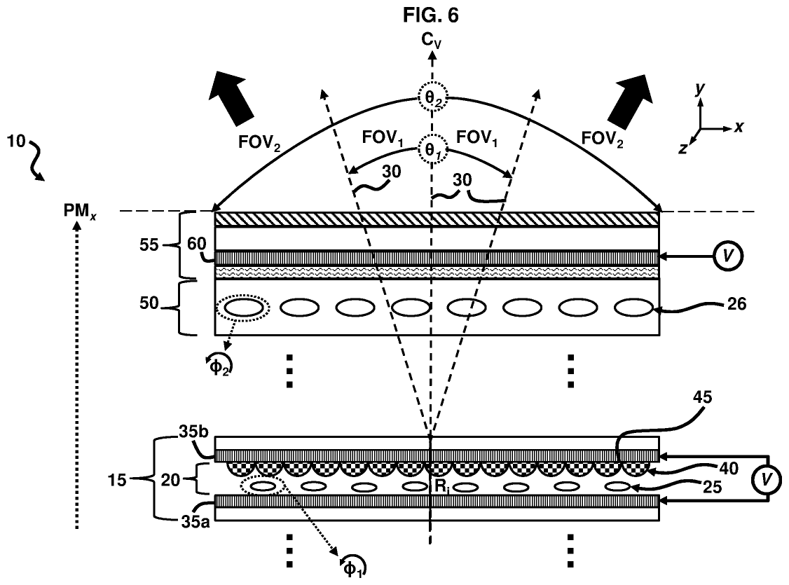

As shown in FIG. 6, with reference to FIGS. 1A through 5, when the micro lens cell 15 is to direct the transmitted light 30 at the first angle θ₁, the light 30 being output from the display device 10 is lowered in intensity and visually black in the second field of vision FOV₂. In this regard, the light 30 being output from the display device 10 that is in the first field of vision FOV₁ may be in a normal display mode; i.e., normal color of light 30 that is being displayed or output by the display device 10. However, the light 30 that is being output from the display device 10 in the second field of vision FOV₂ is in a privacy mode of operation PM), by outputting light 30 that is black and as such, the content being displayed in the normal display color of light 30 in the first field of vision FOV₁ is not viewable in the second field of vision FOV₂. In an example, the intensity of the light 30; i.e., the brightness or luminance of the light 30, may be lower for the low intensity (e.g., visually black) light 30 compared to the scattering (e.g., visually white) light 30. For example, the brightness or luminance of the low intensity light 30 may be approximately 0 to 150 nits while the brightness or luminance of the scattering light 30 may be approximately 0 to 400 nits. In an example, the contrast ratio of the scattering light 30 described with reference to FIG. 4 may be less than the contrast ratio of the low intensity light 30 described with reference to FIG. 6. For example, the contrast ratio of the scattering light 30 of FIG. 4 may be approximately less than 10:1 while the contrast ratio of the low intensity light 30 of FIG. 6 may be approximately greater than 10:1.

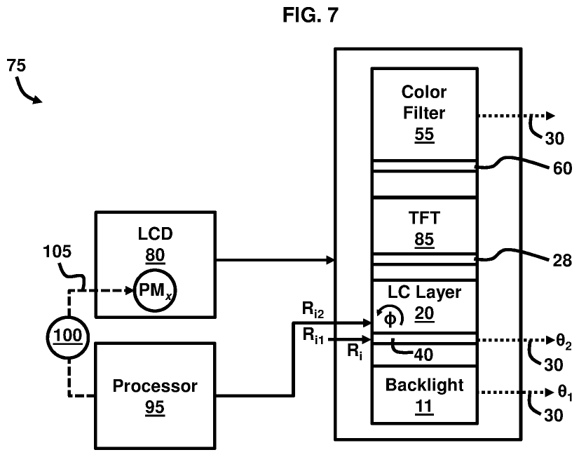

As shown in FIG. 7, with reference to FIGS. 1A through 6, an example electronic device 75 is provided comprising a liquid crystal display 80 that alters between a multiple privacy mode of operation PMₓ. The electronic device 75 may comprise any type of device capable of outputting images and/or light 30 from the liquid crystal display 80. The electronic device 75 may be part of an overall computing or electronic system, or it may be a self-contained electronic device 75 comprising its own processing and memory capabilities, etc. In an example, the light 30 may include a full spectrum of colors generated by a red (R), green (G), and blue (B) combination of pixels. The liquid crystal display 80 may comprise a backlight unit 11 to transmit light 30, and a thin film transistor (TFT) component 85 with a pixel electrode 28, a liquid crystal layer 20 interfacing with a micro lens array 40, in between the backlight unit 11 and the thin film transistor component 85, to alter a projection of the transmitted light 30 from a first projection angle θ₁ to a second projection angle θ₂. The liquid crystal display 80 may comprise a color filter 55 with a common electrode 60 to filter the transmitted light 30 for output. The electronic device 75 comprises a processor 95 to control privacy modes of operation PMₓ of the liquid crystal display 80.

In some examples, the processor 95 described herein and/or illustrated in the figures may be embodied as hardware-enabled modules and may be configured as a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that are configured with electronic circuits process computer logic instructions capable of providing digital and/or analog signals for performing various functions as described herein. The various functions can further be embodied and physically saved as any of data structures, data paths, data objects, data object models, object files, database components. For example, the data objects could be configured as a digital packet of structured data. The data structures could be configured as any of an array, tuple, map, union, variant, set, graph, tree, node, and an object, which may be stored and retrieved by computer memory and may be managed by processors, compilers, and other computer hardware components. The data paths can be configured as part of a computer CPU that performs operations and calculations as instructed by the computer logic instructions. The data paths could include digital electronic circuits, multipliers, registers, and buses capable of performing data processing operations and arithmetic operations (e.g., Add, Subtract, etc.), bitwise logical operations (AND, OR, XOR, etc.), bit shift operations (e.g., arithmetic, logical, rotate, etc.), complex operations (e.g., using single clock calculations, sequential calculations, iterative calculations, etc.). The data objects may be configured as physical locations in computer memory and can be a variable, a data structure, or a function. In the embodiments configured as relational databases, the data objects can be configured as a table or column. Other configurations include specialized objects, distributed objects, object-oriented programming objects, and semantic web objects, for example. The data object models can be configured as an application programming interface for creating HyperText Markup Language (HTML) and Extensible Markup Language (XML) electronic documents. The models can be further configured as any of a tree, graph, container, list, map, queue, set, stack, and variations thereof. The data object files are created by compilers and assemblers and contain generated binary code and data for a source file. The database components can include any of tables, indexes, views, stored procedures, and triggers.

In some examples, the processor 95 may comprise a central processing unit (CPU) of the electronic device 75 or an associated computing device, not shown. In other examples the processor 95 may be a discrete component independent of other processing components in the electronic device 75. In other examples, the processor 95 may be a microprocessor, microcontroller, hardware engine, hardware pipeline, and/or other hardware-enabled device suitable for receiving, processing, operating, and performing various functions required by the electronic device 75. The processor 95 may be provided in the electronic device 75, coupled to the electronic device 75, or communicatively linked to the electronic device 75 from a remote networked location, according to various examples.

According to some examples, the processor 95 is to control a first effective refractive index Rᵢ₁ of the liquid crystal layer 20 by electrically switching an orientation ϕ of the liquid crystal layer 20. For example, the liquid crystal layer 20 may comprise a first set of liquid crystal molecules 25, as described above, such that the processor 95 may electrically switch the orientation ϕ of the first set of liquid crystal molecules 25 in the liquid crystal layer 20 from a uniform orientation to a random orientation and vice versa. In an example, the processor 95 may control the electrical switching by introducing and/or removing an electric field to the liquid crystal layer 20 to induce the change in orientation ϕ of the first set of liquid crystal molecules 25 in the liquid crystal layer 20. In another example, the processor 95 may control the electrical switching by controlling the operation of a voltage source that applies a voltage V to induce the change in orientation ϕ of the first set of liquid crystal molecules 25 in the liquid crystal layer 20.

The processor 95 is to set the first effective refractive index Rᵢ₁ of the liquid crystal layer 20 and an effective refractive index Rᵢ of the micro lens array 40 to be congruent for transmission of the light 30 at the first projection angle θ₁. Moreover, the processor 95 is to set a second effective refractive index Rig of the liquid crystal layer 20 and the effective refractive index Rᵢ of the micro lens array 40 to be incongruent for transmission of the light 30 at the second projection angle θ₂. The electronic device 75 also comprises a switch 100, according to an example, to transmit a signal 105 to the liquid crystal display 80 and the processor 95 to toggle between the modes of operation PMₓ. For example, the switch 100 may be any type of switching device, circuit, or computer-implemented instructions, or a combination thereof. The signal 105 may comprise any suitable type of signal capable of carrying instructions from the processor 95 to the liquid crystal display 80. For example, the signal 105 may comprise an electric, optical, or a magnetic signal, or a combination thereof.

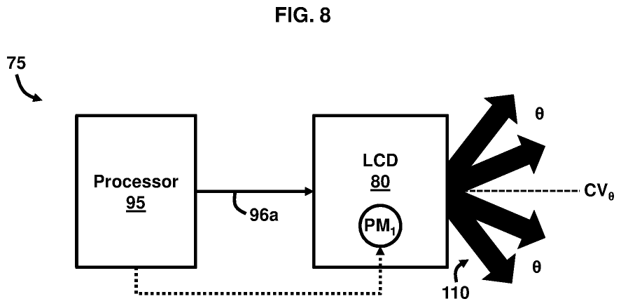

As shown in the example of FIG. 8, with reference to FIGS. 1A through 7, the processor 95 is to select a first privacy mode of operation PM₁ by transmitting instructions 96a to the liquid crystal display 80 to output a low intensity (e.g., visually black-colored) screen display 110 at a viewing angle θ greater than approximately ±30-45° from a center viewing angle CV_{θ} of the liquid crystal display 80. In this regard, the output from the liquid crystal display 80 at the viewing angle θ greater than approximately ±30-45° from a center viewing angle CV_{θ} of the liquid crystal display 80 in the first privacy mode of operation PM₁ by outputting the low intensity (e.g., visually black-colored) screen display 110 and as such, the content being displayed in the viewing angle θ less than approximately ±30-45° from the center viewing angle CV_{θ} of the liquid crystal display 80 is not viewable in the viewing angle θ greater than approximately ±30-45° from a center viewing angle CV_{θ} of the liquid crystal display 80.

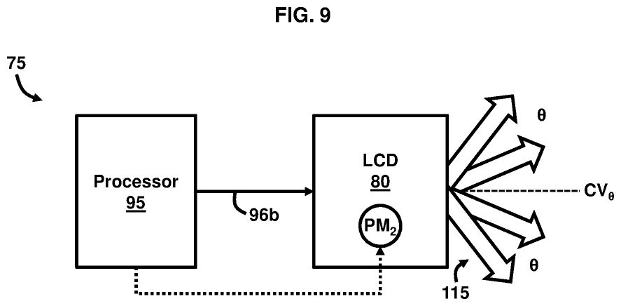

As shown in the example of FIG. 9, with reference to FIGS. 1A through 8, the processor 95 is to select a second privacy mode of operation PM₂ by transmitting instructions 96b to the liquid crystal display 80 to output a light scattering (e.g., visually white-colored) screen display 115 at a viewing angle θ greater than approximately ±30-45° from a center viewing angle CV_{θ} of the liquid crystal display 80. In this regard, the output from the liquid crystal display 80 at the viewing angle θ greater than approximately ±30-45° from a center viewing angle CV_{θ} of the liquid crystal display 80 in the second privacy mode of operation PM₂ by outputting the light scattering (e.g., visually white-colored) screen display 115 and as such, the content being displayed in the viewing angle θ less than approximately ±30-45° from the center viewing angle CV_{θ} of the liquid crystal display 80 is not viewable in the viewing angle θ greater than approximately ±30-45° from a center viewing angle CV_{θ} of the liquid crystal display 80.

As shown in FIG. 10, with reference to FIGS. 1A through 9, the processor 95 is to select a third privacy mode of operation PM₃ by transmitting instructions 96c to the liquid crystal display 80 to output a normal screen display 120 at a viewing angle θ greater than approximately ±30-45° from a center viewing angle CV_{θ} of the liquid crystal display 80, and wherein the normal screen display 120 comprises a screen display output that occurs when viewed at an approximately 0° angle from the center viewing angle CV_{θ} of the liquid crystal display 80. In this regard, the output from the liquid crystal display 80 at the viewing angle θ greater than approximately ±30-45° from a center viewing angle CV_{θ} of the liquid crystal display 80 in the third privacy mode of operation PM₃, which may also be referred to as a sharing mode of operation, by outputting the normal screen display 120 and as such, the content being displayed in the viewing angle θ greater than approximately ±30-45° from the center viewing angle CV_{θ} of the liquid crystal display 80 is viewable in the viewing angle θ less than or greater than approximately ±30-45° from a center viewing angle CV_{θ} of the liquid crystal display 80. In this regard, the output from the liquid crystal display 80 may be shared at all viewable angles with respect to the center viewing angle CV_{θ} of the liquid crystal display 80.

According to an example, the processor 95 is to reduce a power consumption of the liquid crystal display 80 based on the privacy modes of operation PMₓ (e.g., first privacy mode of operation PM₁, second privacy mode of operation PM₂, and third privacy mode of operation PM₃). In an example, the reduction in power consumption of the liquid crystal display 80 may be controlled based on a reduction in the intensity of the light 30 being transmitted to, and output by, the liquid crystal display 80. For example, the light intensity of the light 30 at large angle may be lowered to reduce the power consumption of the liquid crystal display 80.

According to the examples described herein, a user of the display device 10 or the electronic device 75 may switch the display device 10 or the electronic device 75 to function in three modes of operation; namely, a sharing mode, a white-light privacy mode, and a black-light privacy mode.

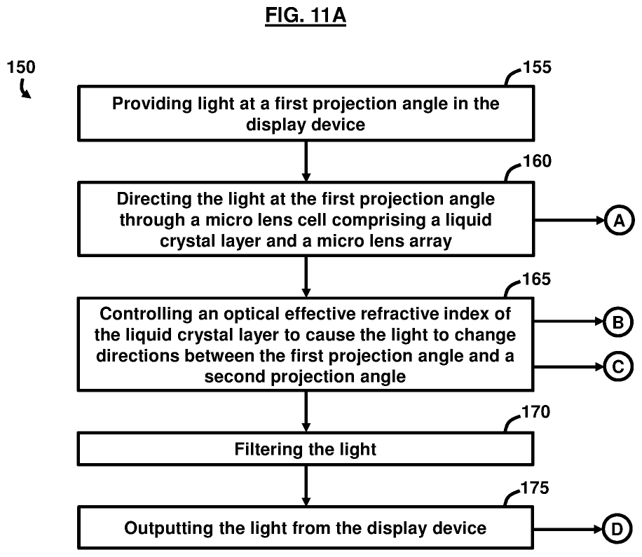

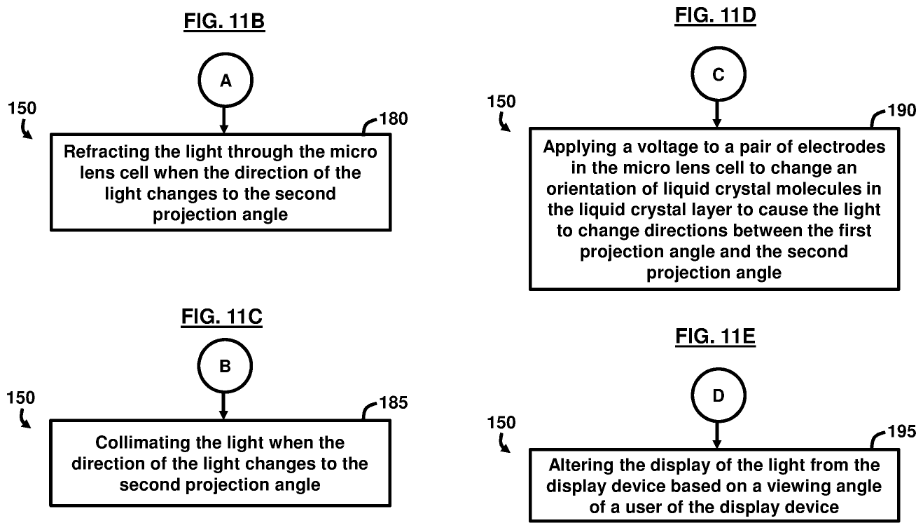

As shown in the example of FIG. 11A, with reference to FIGS. 1A through 10, a method 150 of transmitting light 30 to control a multiple privacy mode of operation PMₓ in a display device 10 is provided. The method 150 comprises, in block 155, providing light 30 at a first projection angle θ₁ in the display device 10. The light 30 may be directed at any appropriate intensity and the first projection angle θ₁ may be at any suitable viewing angle with respect to content being displayed by the display device 10. The method 150 includes, in block 160, directing the light 30 at the first projection angle θ₁ through a micro lens cell 15 comprising a liquid crystal layer; e.g., the first liquid crystal layer 20, and a micro lens array 40. The first liquid crystal layer 20 may comprise a first set of liquid crystal molecules 25 comprising an orientation ϕ that may be switched from a uniform orientation to a non-uniform or random orientation and vice versa. The method 150 comprises, in block 165, controlling an optical effective refractive index Ri of the liquid crystal layer 20 to cause the light 30 to change directions between the first projection angle θ₁ and a second projection angle θ₂ by aligning the optical effective refractive index Rᵢ of the first liquid crystal layer 20 and the micro lens array 40 at the first projection angle θ₁, and misaligning the optical effective refractive index Rᵢ of the first liquid crystal layer 20 and the micro lens array 40 at the second projection angle θ₂. According to an example, a processor 95 may be utilized to control the direction of the light 30 by introducing an electric field to the liquid crystal layer 20 to cause a change in the orientation ϕ of the first set of liquid crystal molecules 25. In block 170, the method 150 comprises filtering the light 30. The filtering of the light 30 may occur in a color filter 55 containing a second liquid crystal layer 23 comprising a second set of liquid crystal molecules 26, which may have switchable orientations; i.e., from a uniform orientation to a non-uniform orientation and vice versa. Block 175 of the method 150 comprises outputting the light 30 from the display device 10. The light 30 may be output at any suitable viewing angle of content being displayed from the display device 10. In some examples, the content may contain any of still images and video images and combinations thereof.

As shown in the example of FIG. 11B, with reference to FIGS. 1A through 11A, the method 150 may comprise, in block 180, refracting the light 30 through the micro lens cell 15 when the direction of the light 30 changes to the second projection angle θ₂. In this regard, in an example, the direction of the light 30 through the micro lens cell 15 may be changed by the processor 95 controlling the direction of the light 30 including introducing an electric field and/or applying a voltage V to the micro lens cell 15. As shown in the example of FIG. 11C, with reference to FIGS. 1A through 11B, the method 150 may comprise, in block 185, collimating or aligning the light 30 when the direction of the light 30 changes to the second projection angle θ₂. In this regard, the collimating of the light 30 may be controlled by the processor 95, according to an example. The collimating of the light 30 may result in enhanced viewing efficiency due to the concentration of the light 30 being output from the liquid crystal display 80. Moreover, the collimating of the light 30 may result in a stronger display of light 30 being output from the liquid crystal display 80 in the viewing angle; e.g., the center viewing angle CV_{θ} of the liquid crystal display 80, for the user of the electronic device 75.

As shown in the example of FIG. 11D, with reference to FIGS. 1A through 110, the method 150 may comprise, in block 190, applying a voltage V to a pair of electrodes 35a, 35b in the micro lens cell 15 to change an orientation ϕ of first set of liquid crystal molecules 25 in the first liquid crystal layer 20 to cause the light 30 to change directions between the first projection angle θ₁ and the second projection angle θ₂. In an example, the first projection angle θ₁ may comprise a narrow projection angle and the second projection angle θ₂ may comprise a wide projection angle that is wider than the narrow projection angle. In another example, the first projection angle θ₁ may comprise a wide projection angle and the second projection angle θ₂ may comprise a narrow projection angle that is narrower than the wide projection angle. As shown in FIG. 11E, with reference to FIGS. 1A through 11D, the method 150 may comprise, in block 195, altering the display of the light 30 from the display device 10 based on a viewing angle α of a user 125 of the display device 10. More, particularly, the light 30 may be displayed from the display device 10 based on a viewing angle α of a user 125 of the display device 10 in combination with the privacy mode of operation PMₓ that the display device 10 is set to be operable. In this regard, when the viewing angle α of the user 125 is positioned such that the user 125 is positioned next to the display device 10, then the light 30 may be displayed as any of a white light, black light, and normal display light.

The present disclosure has been shown and described with reference to the foregoing implementations. Although specific examples have been illustrated and described herein it is manifestly intended that other forms, details, and examples may be made without departing from the scope of the disclosure that is defined in the following claims.

What is claimed is:

1. A display device with a multiple privacy mode of operation, the display device comprising:
a micro lens cell comprising:
a first liquid crystal layer with a first set of liquid crystal molecules and a controllable optical effective refractive index, to transmit light through the micro lens cell;
a pair of electrodes to receive a voltage to change an orientation of the first set of liquid crystal molecules and the optical effective refractive index of the first liquid crystal layer; and
a micro lens array to direct the transmitted light at an interface of the micro lens array and the first liquid crystal layer, the micro lens array to direct the transmitted light at different angles based on the voltage received by the pair of electrodes;
a second liquid crystal layer to change a polarization of the light;
a color filter proximate to the second liquid crystal layer to control a color of the light to be output; and
a common electrode adjacent to the color filter to control an orientation of a second set of liquid crystal molecules in the second liquid crystal layer.

2. The display device of claim 1, wherein the light being output from the display device comprises (i) a first angle comprising a first field of vision that extends from a center view of the display device to approximately 30-45° in each direction, and (ii) a second angle comprising a second field of vision that extends from approximately 30-45° up to 90° in each direction.

3. The display device of claim 2, wherein when the micro lens cell is to direct the transmitted light at the first angle and the second angle, and the common electrode is turned on, the light being output from the display device is scattering and visually white in the second field of vision, and the light being output from the display device is not scattering in the first field of vision.

4. The display device of claim 2, wherein when the micro lens cell is to direct the transmitted light at the first angle and the second angle, and the common electrode is turned off, the light being output from the display device is the same in the first field of vision and the second field of vision.

5. The display device of claim 2, wherein when the micro lens cell is to direct the transmitted light at the first angle, the light being output from the display device is lowered in intensity and visually black in the second field of vision.

6. An electronic device comprising:
a liquid crystal display that alters between a multiple privacy mode of operation and comprising:
a backlight unit to transmit light;
a thin film transistor component with a pixel electrode;
a first liquid crystal layer interfacing with a micro lens array, in between the backlight unit and the thin film transistor component, to alter a projection of the transmitted light from a first projection angle to a second projection angle; and
a color filter with a common electrode to filter the transmitted light for output;
a processor to control privacy modes of operation of the liquid crystal display, wherein the processor is to:
control a first effective refractive index of the first liquid crystal layer by electrically switching an orientation of the first liquid crystal layer;
set the first effective refractive index of the first liquid crystal layer and an effective refractive index of the micro lens array to be congruent for transmission of the light at the first projection angle; and
set a second effective refractive index of the first liquid crystal layer and the effective refractive index of the micro lens array to be incongruent for transmission of the light at the second projection angle;
a switch to transmit a signal to the liquid crystal display and the processor to toggle between the modes of operation.

7. The electronic device of claim 6, wherein the processor is to select a first privacy mode of operation by transmitting instructions to the liquid crystal display to output a black-colored screen display at a viewing angle greater than approximately ±30-45° from a center viewing angle of the liquid crystal display.

8. The electronic device of claim 6, wherein the processor is to select a second privacy mode of operation by transmitting instructions to the liquid crystal display to output a white-colored screen display at a viewing angle greater than approximately ±30-45° from a center viewing angle of the liquid crystal display.

9. The electronic device of claim 6, wherein the processor is to select a third privacy mode of operation by transmitting instructions to the liquid crystal display to output a normal screen display at a viewing angle greater than approximately ±30-45° from a center viewing angle of the liquid crystal display, and wherein the normal screen display comprises a screen display output that occurs when viewed at an approximately 0° angle from the center viewing angle of the liquid crystal display.

10. The electronic device of claim 6, wherein the processor is to reduce a power consumption of the liquid crystal display based on the privacy modes of operation.

11. A method of transmitting light to control a multiple privacy mode of operation in a display device, the method comprising:
providing light at a first projection angle in the display device;
directing the light at the first projection angle through a micro lens cell comprising a liquid crystal layer and a micro lens array;
controlling an optical effective refractive index of the liquid crystal layer to cause the light to change directions between the first projection angle and a second projection angle by aligning the optical effective refractive index of the liquid crystal layer and the micro lens array at the first projection angle, and misaligning the optical effective refractive index of the liquid crystal layer and the micro lens array at the second projection angle;
filtering the light; and
outputting the light from the display device.

12. The method of claim 11, comprising refracting the light through the micro lens cell when the direction of the light changes to the second projection angle.

13. The method of claim 11, comprising collimating the light when the direction of the light changes to the second projection angle.

14. The method of claim 11, comprising applying a voltage to a pair of electrodes in the micro lens cell to change an orientation of liquid crystal molecules in the liquid crystal layer to cause the light to change directions between the first projection angle and the second projection angle.

15. The method of claim 11, comprising altering the display of the light from the display device based on a viewing angle of a user of the display device.
